(19) United States
(12) Patent Application Publication
(10) Pub. No.: US 2018/0255333 A1
(43) Pub. Date: Sep. 6, 2018

(54) SYSTEM AND METHOD FOR REPURCHASING AND RELICENSING ELECTRONIC MEDIA

(71) Applicant: Bilal Soylu, Sanford, NC (US)

(72) Inventor: Bilal Soylu, Sanford, NC (US)

(21) Appl. No.: 15/866,942

(22) Filed: Jan. 10, 2018

Related U.S. Application Data
(60) Provisional application No. 62/467,454, filed on Mar. 6, 2017.

(51) Int. Cl. H04N 21/254; H04N 21/4627; H04N 21/835; H04N 21/266

(52) U.S. Cl. CPC H04N 21/2541; H04N 21/266; H04N 21/835; H04N 21/4627

(57) ABSTRACT

A system and method to automatically repurchase and relicense electronic media. The XcooBee automatic licensing system addresses short comings of current system and builds on Digital Fingerprinting and Rights management with effective user behavior expectations. It ensures that right holders can set use policies for their content. Such policies describe licensing in terms of sharing and the network's ability to automatically license the shared content when needed. In this context, the content owners are not preventing sharing the licensed content, on the contrary, they are encouraging licensee to do so. By the same token, licensees are ensured that none of their sharing activities would be considered illegal since automatic licensing would be invoked when needed.

### CROSS-REFERENCE TO RELATED APPLICATION

This application claims the benefit of priority of U.S. provisional application No. 62/467,454, filed Mar. 6, 2017, the contents of which are herein incorporated by reference.

### BACKGROUND OF THE INVENTION

The present invention relates to digital media content, and more particularly to systems and methods for the purchase and licensing of such digital media content.

Digital media content, such as music and video, is currently being generated and exchanged between organizations and individuals at a faster pace. After the initial exchange, the current exchange mechanisms such as email and file downloads, do not have a means of tracking whether the content that is being is exchanged on networks is subject to additional licensing. Similarly, owners do not know when secondary copies of their work are being exchanged without payment.

Previously, right-holders, like music artists and others had to rely on tools not directly meant for distribution of content. The existing tools only focus on either providing a key based play-back lock, or catching an offender with stored content. Neither of these approaches solves the actual problem of the right holder, getting revenue for their work while also ensuring the recipient that the item is properly licensed. This software fills the void.

In addition, recipients have no way of knowing whether the copy they believe to be legitimate is truly licensed correctly for their use. Moreover, content owners do not have a means to catch and assign licensing policies for their content easily while content consumers do not have a way to track the legitimacy of the purchased content or understand their right to resale if any.

Current systems that are sold and used, focus on digital rights management. This is guided by the thought that copyrighted works should not be able to be copied freely and an equivalent mechanism to a physical door lock, in the form of a digital lock, is necessary to protect owner's intellectual property rights. This misses the problem in two substantial ways. First, the right owner's primary interest is in ensuring they are converting content to revenue. Thus, the digital lock is contrary to that since it can only work in proxy with the hope that users eventually license the content. Second, it acts counter to common human social behavior, which is to share content with the immediate and even larger social group. The result is an ineffective solution for right owners and consumer alike.

As can be seen, there is a need for an improved system and method for the repurchase and relicensing of digital content.

### SUMMARY OF THE INVENTION

Aspects of the present invention, include a method of a content distribution service provider to distribute digital content over a network. The method includes registering a digital content with the server or network of the content distribution service provider via a content distribution network associated with the content distribution service provider. The server of the content distribution service provider automatically assigns a digital fingerprint to the digital content. The assigned digital fingerprint is assigned to a distributed transaction database that is in communication with the server of the content distribution service provider. The content distribution network is then monitored for an exchange of the digital content according to the digital fingerprint. Upon detection of an exchange of the digital content, a license transaction is automatically generated. When license transaction is accepted by a licensee, a transaction signature is automatically generated.

The server is configured to automatically deliver the digital content to the licensee upon acceptance of the license transaction. The method also includes automatically adding the digital transaction signature or digital fingerprint to the distributed transaction database. When added, the content distribution network is monitored for a subsequent exchange of the digital content between the licensee and a next recipient according to the digital fingerprint and the transaction signature.

The method also permits the rights owner to set a policy for the distribution of the digital content on the content distribution network. During a subsequent exchange of the digital content, the method automatically determines whether the subsequent exchange conforms to the policy. If the subsequent exchange conforms to the policy, the method automatically generates a subsequent license transaction. If the subsequent exchange does not conform to the policy, the network is configured to automatically prompt the rights owner to consider an exception request. If the rights owner approves the exception request, the subsequent license transaction is presented for execution. If the rights owner declines the exception request, the transfer of the digital content is terminated.

Other aspects of the invention included automatically generating a subsequent transaction signature upon acceptance of the subsequent license transaction by the next recipient and automatically delivering the digital content to the next recipient upon acceptance of the subsequent license transaction. The subsequent transaction signature for the subsequent license is then added to the distributed transaction database.

Other aspects of the invention include the right owner assigning policies to allow sublicensing of the content where the initial recipient of the digital content is allowed to distribute content to third parties while connecting fees outlined in the initial policy.

Other aspects of the invention include the initial and subsequent recipients sharing content freely over the content-delivery network. The network prompting each subsequent recipient for license payments where needed.

Other aspects of the invention include the digital content owner setting distribution policies allowing digital delivery network to ask initial recipient to assume license charges if the recipient distributes content to any other party.

Yet other aspects of the invention include automatically transferring a license revenue to the rights owner. In addition, the method may also include presenting a distribution history of the digital content to the rights owner. A revenue history of the digital content may also be presented to the rights owner.

These and other features, aspects and advantages of the present invention will become better understood with reference to the following drawings, description and claims.

### BRIEF DESCRIPTION OF THE DRAWINGS

FIG. 1 is a schematic diagram of a repurchasing and relicensing cycle for electronic media.

FIG. 2 is a flow chart of the system and method for repurchasing and relicensing electronic media.

FIG. 3 is a flow chart of the system and method for repurchasing and relicensing electronic media.

FIG. 4 is a representative system architecture for a content distribution network.

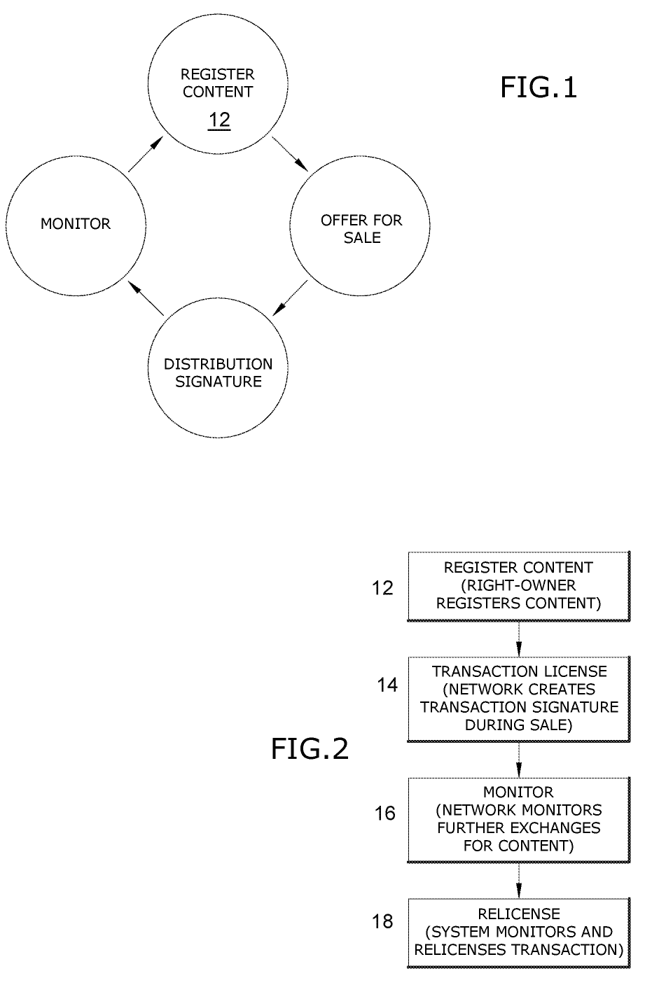

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention address both short comings of the current system of digital rights management and builds on Digital Fingerprinting and Rights management with effective user behavior expectations. It ensures that right holders can set use policies for their content. Such policies describe licensing in terms of sharing and a network's ability to automatically license the shared content when needed. In this context, the content owners are not preventing sharing the licensed content, on the contrary, they are encouraging licensees to do so. By the same token, licensees are ensured that none of their sharing activities would be considered illegal since automatic licensing would be invoked when needed.

As stated above, Digital content such as music and video is being generated and exchanged between organizations and individuals at a faster pace. After the initial exchange, the current exchange mechanisms such as email and file downloads, do not have a means of tracking whether the content that is being exchanged on networks is subject to additional licensing. Similarly, owners do not know when secondary copies of their work are being exchanged without payment. In addition, recipients have no way of knowing whether the copy they believe to be legitimate is truly licensed correctly for their use. Moreover, content owners do not have a means to catch and assign licensing policy for their content easily while content consumers do not have a way to track the legitimacy of the purchased content or understand their right to resale if any.

By using a combination of digital signatures, digital fingerprints, and a secure XcooBee global network to exchange digital media, right-holders can have the network track all exchanges of their content and automatically assign a license when needed. Right owners can collect revenue for newly issued licenses. Similarly, licensees are assured that the received media is properly licensed even when purchasing the media from third party sources.

A system according to aspects of the present invention may include a computer network 1 that connects consumers and businesses and is accessible via the general Internet, hereinafter the XcooBee network, which includes a server 3, a network distributed secure storage system 2. The XcooBee network server 3 is configured with a network software and associated network equipment hardware. A computing device 4, such as a smart mobile device, tablet, personal computer, or laptop, preferably with global positioning system (GPS) functionality such as an Apple iPhone or Samsung Galaxy. An app (software instructions) may be downloadable by user to the computing device 4, onto a local storage for the computing device 4. The system may also implement a digital content signature 6 and a digital transaction signature 9.

The digital content signature may be utilized to guarantee the state of the content 8 at a point in time, such as via trusted time stamping to verify the authenticity or integrity of the content 8. The digital content signature 8 may also include embedded hidden information (Steganography) within the content 8. When used in conjunction with an encrypted digital key, may be utilized to make the content 8 inaccessible without the encryption key.

The digital transaction signature 9 is a unique identifier applied to a selected copy of the digital content 8 and is utilized to track an initial and one or more subsequent licenses of the digital content 8 via the network. Implementation may also include a distributed transaction database, such as the block-chain database 5 for recording and tracking the digital transaction signature 9 to determine the distribution of the content 8 on the network.

The mobile app is installed on the mobile device 4. The mobile app translates user interactions (taps, clicks, swipes and entries), with the mobile app into commands to be processed by network software. The network software will cause data to be stored in the distributed storage 2. The computer network 1 modifies and transports data stored in distributed storage 2 according to instructions and business logic in network software.

The user can use the mobile app to either initiate a data-share or the rights owner can send content 8 via the mobile app through the computer network 1 to a recipient (licensee). The network software will store and forward information using the network storage 2. During transfer from the rights-owner to the licensee, the network software will add the digital signature 9 to the content and create an appropriate tracking keys in the distributed transaction database 2. This digital transaction signature 9 is unique and identifies the particular transaction between the rights-owner and the licensee. The network software 3 may also create corresponding file signatures to identify content 8 in generic terms.

The rights-owner can specify and provide rights management policies to the network software such that the network software is aware of a desired outcome and relicense options, should the exchanged content 8 be discovered again. The network software continually monitors content 8 exchanges. When the network detects an exchange attempt of the same digital content 8 it will automatically ask either a recipient or a sender to relicense of content under the terms set by license owner. It will also provide such 3rd party senders and recipients with an option to apply for a license exception to justify the exchange if they believe this to be fair use. The network, will then, relicense the digital content 8, apply new set of digital signatures 9 and collect a license fee, if any, for the right owner and deliver the content 8 to the newly designated recipient.

As an alternative to the mobile app a standard PC or Laptop 4′ with a standard web-browser software such as Internet Explorer, Chrome, or Safari can be used. The software instructions of network will be loaded into the web-browser running on the standard PC or Laptop 4′. As an alternative to a directed exchange, the rights owner can provide digital content 8 for digital content signature generation ahead of time.

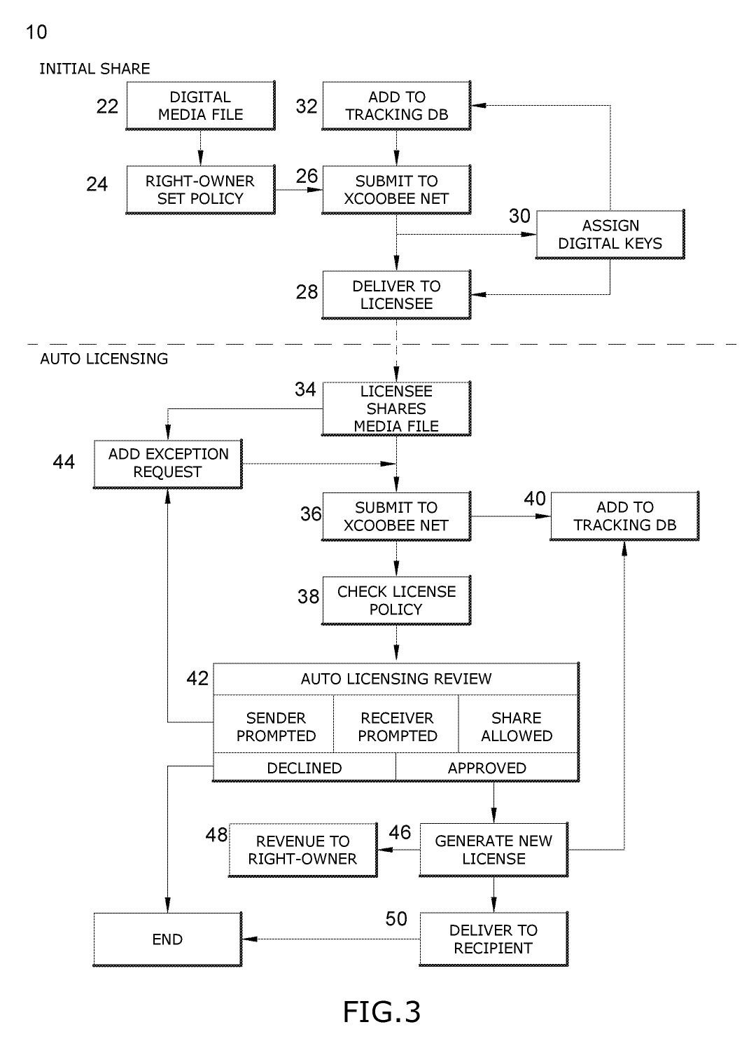

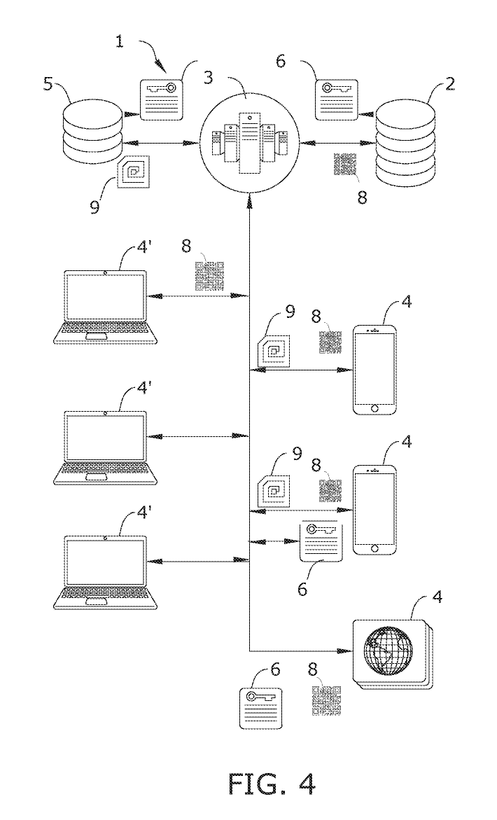

As seen in reference to FIGS. 2 and 3, a method according to aspects of the present invention starts with the desire to approach licensing as a transparent element of sharing. At block 22, a rights owner may pre-register their content 8 and at block 24 may set policies for the network to track all exchanges of the content 8 and submit it to the XCOOBEE Net at block 26. In the initial sharing or a subsequent distribution of the content 8, the rights owner may set policy options on the XcooBee network through a license distribution page that may be used as defaults for an exchange.

The network may automatically register and assign 30 a digital fingerprint to the content 8 during the initial exchange. The system creates a transaction license, wherein the system creates a transaction signature, for example during a sale or exchange of the content, which is added to the tracking database 5 and delivers the content to the licensee at 28.

The method then entails monitoring further exchanges of the content 8 within the network 10. When the system detects a subsequent exchange of the content 8 at block 34, the opportunity to relicense the content 8 is presented.

The exchange process can be initiated from either or both parties to a transaction, a licensee or a rights owner. The licensee can request digital content 8 via an appropriate bee in the XcooBee network. The licensee can also request specific license use rights via the bee parameters. The rights owner can respond to license requests and send media via an XcooBee bee. The rights owner can also send raw digital content 8 via the XcooBee network using the designated auto licensing bee. The rights owner can also determine specific license policy and right exceptions and can permit movement of a license, set a license expiration parameter (time, after x shares, etc.), can specify relicense parameters, and conditions where approval may be required.

The network handles the exchange of the digital media 8. If the digital media 8 is not registered, at block 40, the network will register the content 8 with the tracking database 6, at which time the network will add a transaction signature to the tracking list. The network software will digitally sign the digital content with a new transaction signature. The specific rights and license restrictions for the transactions will also be registered with the network and at block 50 deliver the registered content to licensee.

If the licensee shares the content with other users (recipients) not originally part of the transaction via the network, the network will review the license policy. If a new license is needed, the network will either ask the sender or the recipient for payment of a license fee. The network will consider options set on profiles for both sender and recipient. If either sender or recipient allows for auto charging of license, it will use this decision matrix to license the content.

The network may also prompt either the sender or recipient for an additional purchase. If either party agrees to purchase, the network will add license to the transaction and generate new transaction key to track subsequent exchanges from this point on. Alternatively, if so configured, the auto licensing review module 42 may prompt for an exception justification to be either automatically handled by licensing review module 42 or be forwarded to the rights owner for review. If no new license is needed the exchange is registered for reporting.

Any user of XcooBee network can hire a special purpose XcooBee bee to find out whether a given digital media file has been licensed correctly for their use. This process is free if the rights owner subscribes to the monitoring service. In this instance, the network maintains a database of all exchanges of licensed content that can be used for reporting by rights owners. Once the rights owner decides to participate in automatic relicensing program he/she must determine appropriate use policies for each or a grouping of content files 8. These policies determine whether content can be licensed by 3rd party for an extra fee (commission), if content is shared further, who is allowed to pay (recipient, sender). Similarly, what type of exceptions are allowed to be handled by XcooBee network such as fair use claims etc.

The right holder may also set gates for one or more types of inherited options, for example if a company purchases content 8, are subsidiaries allowed to use it? Are there regional restrictions that the content may not travel?

During a sale of licensed content 8 the rights owner may indicate how long the content is available, whether it can be resold etc. A link to a general policy document of the rights holder can also be embedded digitally.

The recipient of secondary and tertiary content 8 can similarly make decisions surrounding the acceptance and automatic license of content 8. They can direct the software to automatically license content up to a certain price or always reject or review such content 8 licensing requests. The sender may opt to pay additional license fees so that the recipient is not asked for them.

In use, the rights owner or licensee can initiate the process interchangeably. Normally, the rights owner initiates the data-sharing process on the mobile app, desktop or API (application programming interface). He or she simply picks the content to share and the condition that would apply to the license as well as the destination (the licensee). All standard elements are defaulted from the rights owner's profile. Once the content is submitted to the network, the system will generate digital content and transaction signatures and present the content to the licensee. The rights owner may track acceptance of content, generated revenue, as well as any further shares of the content via app or desktop.

The licensee, can simply send content 8 to others via the XcooBee network. The network will monitor and ask either recipients or the sender via app or desktop interface to agree to license terms and submit payment if needed. Content 8 will only be delivered if all terms are met.

A recipient of content through other channels, i.e. common internet downloads, can use the XcooBee app, desktop web interface, or API to submit the content for analysis and licensing. The network software will determine whether a license is needed and generate one for the user automatically.

Licensees can use the XcooBee app, web interface, or API to request licensed content from rights owners. During this exchange, licensees are able to request alternate license terms. If the network software has the information to generate the license, it will do so automatically, and return digitally signed and registered content. If not, the rights owner will use the XcooBee app, web interface, or API to approve the request before XcooBee network transfers the content. The ability of the XcooBee network to track the exchange of documents by generated electronic signature allows the invention to be used to create profiles of exchanges, even if no re-licensing mechanism is used. Reporting can also be generated with geographic usage patterns as well as share patterns for rights owners even if the software does not automatically re-license.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of a content distribution service provider to distribute digital content over a network, the method comprising:
registering a digital content with the server of the content distribution service provider via a content distribution network associated with the content distribution service provider;
automatically assigning a digital fingerprint to the digital content at the server of the content distribution service provider;
adding the assigned digital fingerprint to a distributed transaction database that is in communication with the server of the content distribution service provider;
monitoring the content distribution network for an exchange of the digital content according to the digital fingerprint;
automatically generating a license transaction upon detection of an exchange of the digital content.

2. The method of claim 1, further comprising:
automatically generating a transaction signature upon acceptance of the license transaction by a licensee;
automatically delivering the digital content to the licensee upon acceptance of the license transaction.

3. The method of claim 2, further comprising:
automatically adding the digital transaction signature to the distributed transaction database.

4. The method of claim 3, further comprising:
monitoring the content distribution network for a subsequent exchange of the digital content between the licensee and a next recipient according to the digital fingerprint and the transaction signature.

5. The method of claim 4, further comprising:
setting a policy for the distribution of the digital content on the content distribution network by a rights owner of the digital content.

6. The method of claim 5, further comprising:
automatically determining whether the subsequent exchange conforms to the policy;
if the subsequent exchange conforms to the policy, automatically generating a subsequent license transaction; and
if the subsequent exchange does not conform to the policy, automatically prompting the rights owner to consider an exception request;
if the rights owner approves the exception request, presenting the subsequent license transaction;
if the rights owner declines the exception request, denying the transfer of the digital content.

7. The method of claim 6, further comprising;
automatically generating a subsequent transaction signature upon acceptance of the subsequent license transaction by the next recipient;
automatically delivering the digital content to the next recipient upon acceptance of the subsequent license transaction.

8. The method of claim 7, further comprising:
automatically adding the subsequent transaction signature for the subsequent license to the distributed transaction database.

9. The method of claim 6, further comprising:
automatically transferring a license revenue to the rights owner.

10. The method of claim 9, further comprising:
presenting a distribution history of the digital content to the rights owner.

11. The method of claim 9, further comprising:
presenting a revenue history of the digital content to the rights owner.

12. A computer-readable memory adapted for use by a content distribution service provider to distribute digital content over a network, the computer-readable memory used to direct a computer of the content distribution service provider to perform the steps of:
registering a digital content with the server of the content distribution service provider via a content distribution network associated with the content distribution service provider;
automatically assigning a digital signature to the digital content at the server of the content distribution service provider;
adding the assigned digital signature to a distributed transaction database that is in communication with the server of the content distribution service provider;
monitoring the content distribution network for an exchange of the digital content according to the digital signature;
automatically generating a license transaction upon detection of an exchange of the digital content.

13. The computer-readable memory of claim 12, further comprising:
automatically generating a transaction signature upon acceptance of the license transaction by a licensee;
automatically delivering the digital content to the licensee upon acceptance of the license transaction.

14. The computer-readable memory of claim 13, further comprising:
automatically adding the digital transaction signature to the distributed transaction database.

15. The method of claim 14, further comprising:
monitoring the content distribution network for a subsequent exchange of the digital content between the licensee and a next recipient according to the digital key and the transaction signature.

16. The method of claim 15, further comprising:
setting a policy for the distribution of the digital content on the content distribution network by a rights owner of the digital content.

17. The method of claim 16, further comprising:
automatically determining whether the subsequent exchange conforms to the policy;
if the subsequent exchange conforms to the policy, automatically generating a subsequent license transaction; and
if the subsequent exchange does not conform to the policy, automatically prompting the rights owner to consider an exception request;
if the rights owner approves the exception request, presenting the subsequent license transaction;
if the rights owner declines the exception request, denying the transfer of the digital content.

18. The method of claim 17, further comprising;
automatically generating a subsequent transaction signature upon acceptance of the subsequent license transaction by the next recipient;
automatically delivering the digital content to the next recipient upon acceptance of the subsequent license transaction.

19. The method of claim 18, further comprising:
automatically adding the subsequent transaction signature for the subsequent license to the distributed transaction database.

20. The method of claim 17, further comprising:
automatically transferring a license revenue to the rights owner.
